(19) United States
(12) Patent Application Publication
(10) Pub. No.: US 2023/0332780 A1
(43) Pub. Date: Oct. 19, 2023

(54) LIQUID DESICCANT AIR CONDITIONING USING AIR AS HEAT TRANSFER MEDIUM

(71) Applicant: Mojave Energy Systems, Inc., Palo Alto, CA (US)

(72) Inventors: Aaron Meles, Grand Rapids, MI (US); Rachel Ellman, Palo Alto, CA (US); Chris Savarino, Rancho Cordova, CA (US)

(21) Appl. No.: 17/719,598

(22) Filed: Jul. 31, 2023

(51) Int. Cl. F24F 3/14; F24F 3/153

(52) U.S. Cl. CPC F24F 3/1417; F24F 3/153; F24F 2003/1452; F24F 2003/1458

(57) ABSTRACT

A liquid desiccant system includes a liquid desiccant loop having an absorber unit in fluid communication with a desorber unit and liquid desiccant flowing between the absorber unit and the desorber unit. The liquid desiccant system includes a supply airflow path passing through the absorber unit and forming an absorber liquid/air interface within the absorber unit and a conditioned airflow exiting the absorber unit. The liquid desiccant system includes a regeneration airflow path passing through the desorber unit and forming a desorber liquid/air interface within the desorber unit and an exhaust airflow exiting the desorber unit. A heat exchanger is thermally coupled to the supply airflow path for removing heat from supply airflow upstream of the absorber unit. A heat exchanger is thermally coupled to the regeneration airflow path adding heat to regeneration airflow upstream of the desorber unit.

### SUMMARY

The present disclosure relates generally to air dehumidifying systems that utilize liquid desiccant.

The present disclosure is directed to a liquid desiccant system where heat and mass transfer occurs only at a liquid/air interface within the desorber unit and absorber unit. The liquid desiccant system may not include a desiccant-to-liquid (such as water or refrigerant) heat exchanger, thus reducing complexity and cost of the liquid desiccant system while enabling a highly efficient air dehumidifying system.

The present disclosure is directed to a liquid desiccant system including a liquid desiccant loop having an absorber unit in fluid communication with a desorber unit and liquid desiccant flowing between the absorber unit and the desorber unit. The liquid desiccant system includes a supply airflow path passing through the absorber unit and forming an absorber liquid/air interface within the absorber unit and a conditioned airflow exiting the absorber unit. The liquid desiccant system includes a regeneration airflow path passing through the desorber unit and forming a desorber liquid/air interface within the desorber unit and an exhaust airflow exiting the desorber unit. A heat exchanger is thermally coupled to the supply airflow path for removing heat from supply airflow upstream of the absorber unit. A heat exchanger is thermally coupled to the regeneration airflow path adding heat to regeneration airflow upstream of the desorber unit. At least 95%, or at least 99% of the total heat added to the liquid desiccant may be added at the desorber liquid/air interface.

The present disclosure is directed to a liquid desiccant system including a liquid desiccant loop having an absorber unit in fluid communication with a desorber unit and liquid desiccant flowing between the absorber unit and the desorber unit. The liquid desiccant system includes a supply airflow path passing through the absorber unit and forming an absorber liquid/air interface within the absorber unit and a conditioned airflow exiting the absorber unit. The liquid desiccant system includes a regeneration airflow path passing through the desorber unit and forming a desorber liquid/air interface within the desorber unit and an exhaust airflow exiting the desorber unit. A heat exchanger is thermally coupled to the supply airflow path for removing heat from supply airflow upstream of the absorber unit. The heat exchanger is also thermally coupled to the regeneration airflow path adding heat to regeneration airflow upstream of the desorber unit. At least 95%, or at least 99% of the total heat added to the liquid desiccant may be added at the desorber liquid/air interface.

The present disclosure is directed to a method of conditioning an airflow including circulating liquid desiccant through a liquid desiccant loop including an absorber unit in fluid communication with a desorber unit and liquid desiccant, flowing supply air along a supply airflow path and through the absorber unit to form an absorber liquid/air interface within the absorber unit and a conditioned airflow exiting the absorber unit, and flowing regeneration air along a regeneration airflow path and through the desorber unit to form a desorber liquid/air interface within the desorber unit and an exhaust airflow exiting the desorber unit. The method includes removing heat from the supply air upstream of the absorber unit and adding heat to the regeneration airflow upstream of the desorber unit. The liquid desiccant has a first temperature exiting the desorber unit and a second temperature entering the absorber unit and the first and second temperature at within 5% of each other, or within 1% of each other, or are equal. At least 95%, or at least 99% of the total heat added to the liquid desiccant may be added at the desorber liquid/air interface.

The present disclosure is directed to a method of conditioning an airflow including circulating liquid desiccant through a liquid desiccant loop comprising an absorber unit in fluid communication with a desorber unit and liquid desiccant, flowing supply air along a supply airflow path and through the absorber unit to form an absorber liquid/air interface within the absorber unit and a conditioned airflow exiting the absorber unit, and flowing regeneration air along a regeneration airflow path and through the desorber unit to form a desorber liquid/air interface within the desorber unit and an exhaust airflow exiting the desorber unit. The method includes removing heat from the supply air upstream of the absorber unit and adding the heat to the regeneration airflow upstream of the desorber unit. The liquid desiccant has a first temperature exiting the desorber unit and a second temperature entering the absorber unit and the first and second temperature at within 5% of each other, or within 1% of each other, or are equal. At least 95%, or at least 99% of the total heat added to the liquid desiccant may be added at the desorber liquid/air interface.

The present disclosure is directed to a liquid desiccant system including a liquid desiccant loop having an absorber unit in fluid communication with a desorber unit and liquid desiccant flowing between the absorber unit and the desorber unit. The liquid desiccant system includes a supply airflow path passing through the absorber unit and forming an absorber liquid/air interface within the absorber unit and a conditioned airflow exiting the absorber unit. The liquid desiccant system includes a regeneration airflow path passing through the desorber unit and forming a desorber liquid/air interface within the desorber unit and an exhaust airflow exiting the desorber unit. A heat exchanger is thermally coupled to the supply airflow path for removing heat from supply airflow upstream of the absorber unit. The heat exchanger is also thermally coupled to the regeneration airflow path adding heat to regeneration airflow upstream of the desorber unit. The liquid desiccant loop does not include a refrigerant-to-liquid heat exchanger or a water-to-liquid desiccant heat exchanger.

The present disclosure is directed to a method of conditioning an airflow including circulating liquid desiccant through a liquid desiccant loop including an absorber unit in fluid communication with a desorber unit and liquid desiccant, flowing supply air along a supply airflow path and through the absorber unit to form an absorber liquid/air interface within the absorber unit and a conditioned airflow exiting the absorber unit, and flowing regeneration air along a regeneration airflow path and through the desorber unit to form a desorber liquid/air interface within the desorber unit and an exhaust airflow exiting the desorber unit. The method includes removing heat from the supply air upstream of the absorber unit and adding heat to the regeneration airflow upstream of the desorber unit. The liquid desiccant loop does not include a refrigerant-to-liquid heat exchanger or a water-to-liquid desiccant heat exchanger.

### BRIEF DESCRIPTION OF THE DRAWINGS

The discussion below makes reference to the following figures, wherein the same reference number may be used to identify the similar/same component in multiple figures. The figures are not necessarily to scale.

FIG. 1 is a schematic diagram of an illustrative liquid desiccant system; and

FIG. 2 is a schematic diagram of another illustrative liquid desiccant system.

### DETAILED DESCRIPTION

The present disclosure is generally related to heating, ventilation, and air-conditioning (HVAC) systems. In one example embodiment, a gas-to-liquid vapor exchanger includes an absorber unit and a desorber unit to regenerate a liquid desiccant passing thorough both units. These units can be used to absorb and desorb water vapor into and out of the liquid desiccant to dehumidify or humidify air. This humidification and dehumidification can be used in HVAC heating and cooling applications.

Air conditioning systems may simultaneously perform two functions: first to dehumidify and second to cool a forced air stream. Commonly used air conditioning systems use vapor compression, which can both dehumidify and cool the incoming air. However, given a humid air stream, vapor compression may rely on cooling the air stream to below its delivery temperature to condense the moisture and achieve a low absolute humidity, then re-heating the air to its delivery temperature. This moisture condensation process dramatically increases the energy requirement of air conditioners, especially in humid climates. An alternative dehumidification method, known as liquid desiccant dehumidification, can substantially decrease the energy intensity of air conditioning, and is the subject of the present disclosure.

Removing moisture from air using a liquid desiccant is an energy-efficient alternative to vapor compression, since it minimizes or removes the need for cooling and reheating the air stream. In a liquid desiccant dehumidification system, the humid air exchanges water vapor with the liquid desiccant. A gas-to-liquid vapor exchanger (absorber unit) may be used to contact humid air and a liquid desiccant and transfer water vapor in the humid air into the liquid desiccant to form a loaded liquid desiccant. This loaded liquid desiccant may be regenerated in a gas-to-liquid vapor exchanger (desorber unit) by heating the loaded liquid desiccant to drive off water vapor and return the regenerated liquid desiccant to the absorber unit.

The present disclosure is directed to a liquid desiccant system where heat and mass transfer occurs only at a liquid/air interface within the desorber unit and absorber unit. Heat is added or removed from the liquid desiccant only at the liquid/air interface within the desorber unit and absorber unit. The liquid desiccant system may not include a desiccant-to-liquid (such as water or refrigerant) heat exchanger, thus reducing complexity and cost of the liquid desiccant system while enabling a highly efficient air dehumidifying system.

Current liquid desiccant air conditioning systems utilize cooling and heating of the liquid desiccant using heat exchangers. These heat exchanges are typically counter-flow unit operations that provide a heating or cooling liquid flowing in a first direction and the liquid desiccant flowing in an opposite direction and transferring heat via thermal conduction through the heat exchanger conduit walls. These heat exchangers are formed of exotic materials to handle the corrosive liquid desiccant and are thus expensive and complex.

The present disclosure eliminates these desiccant-to-liquid heat exchangers while providing a highly efficient liquid desiccant air conditioning system. The present disclosure provides a simplified liquid desiccant air conditioning system that may be easily retrofitted onto traditional air conditioning systems. The present disclosure describes a highly efficient liquid desiccant air conditioning system that utilizes standard air coils to heat and cool the air entering the absorber unit and the desorber unit. The air passing through the absorber unit and the desorber unit provides the heating and cooling of the liquid desiccant. This simplifies system architecture, removes expensive parts, and opens the door to liquid desiccant retrofits of existing traditional air conditioners.

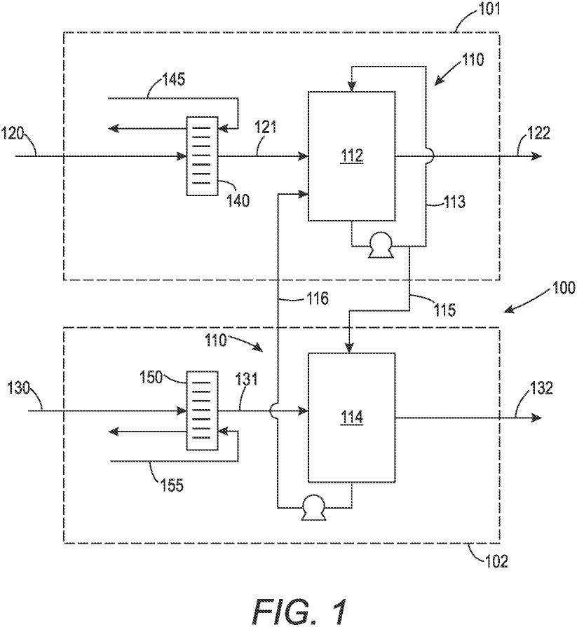

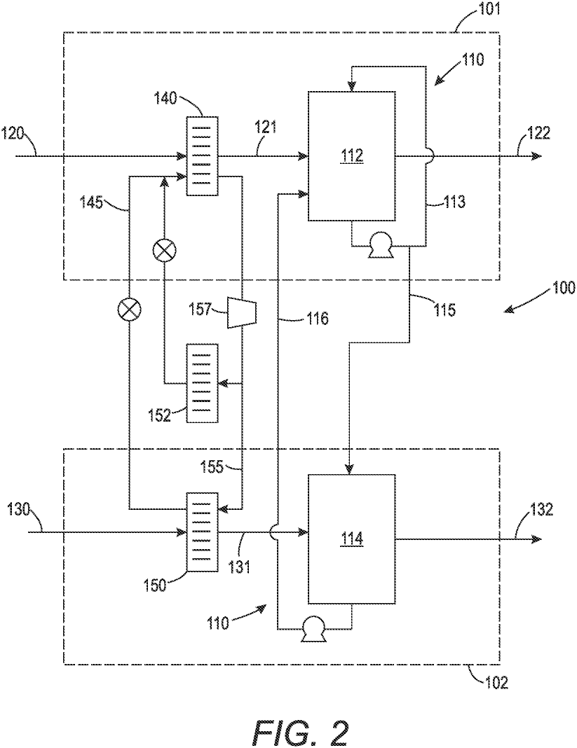

FIG. 1 is a schematic diagram of an illustrative liquid desiccant system 100. FIG. 2 is a schematic diagram of another illustrative liquid desiccant system 100. The liquid desiccant system 100 of FIG. 2 illustrates heat removed from an absorber operation 101 is added to the desorber operation 102. The liquid desiccant system 100 of FIG. 1 illustrates that heat is removed from the absorber operation 101 via a heat sink 145 and heat is added to the desorber operation 102 via a heat source 155. The heat sink 145 may be any useful heat sink unit operation that removes heat from the absorber operation 101, such as, refrigerant-to-air condenser coil, chilled water coil, evaporative coolers, and the like. The heat source 155 may be any useful heat source unit operation that provides heat to the desorber operation 102 such as, electric heat, gas-fired heat, solar heat, geothermal heat, condenser coil, and the like.

The liquid desiccant system 100 includes a liquid desiccant loop 110 having an absorber unit 112 in fluid communication with a desorber unit 114 and liquid desiccant flowing between the absorber unit 112 and the desorber unit 114.

The liquid desiccant system 100 includes a supply airflow path 120 passing through the absorber unit 112 and forming an absorber liquid/air interface within the absorber unit 112 and a conditioned airflow 122 exiting the absorber unit 112. The liquid desiccant system 100 includes a regeneration airflow path 130 passing through the desorber unit 114 and forming a desorber liquid/air interface within the desorber unit 114 and an exhaust airflow 132 exiting the desorber unit 114.

A heat exchanger 140 is thermally coupled to the supply airflow path 120 for removing heat from supply airflow 120 upstream of the absorber unit 112. A heat exchanger 150 is thermally coupled to the regeneration airflow path 130 adding heat to regeneration airflow 130 upstream of the desorber unit 114.

The liquid desiccant has a first temperature exiting the absorber unit 112 and a second temperature entering the desorber unit 114, and the first and second temperature are within 5% of each other, or within 1% of each other, or are equal. At least 95%, or at least 99% of the total heat added to the liquid desiccant may be added at the desorber liquid/air interface.

The liquid desiccant has a first temperature exiting the desorber unit 114 and a second temperature entering the absorber unit 112, and the first and second temperature are within 5% of each other, or within 1% of each other, or are equal. At least 95%, or at least 99% of the total heat removed to the liquid desiccant may be removed at the absorber liquid/air interface.

In the absorber operation 101, the heat exchanger 140 may include an evaporator coil within the supply airflow path 120 configured to remove heat from the supply airflow. Cooled supply airflow 121 then enters the absorber unit 112 to both cool (remove heat from) the liquid desiccant and transfer humidity from the cooled supply airflow to the liquid desiccant at the absorber liquid/air interface.

The absorber liquid/air interface may be formed by any vapor/liquid mass transport unit operation. Illustrative vapor/liquid mass transport unit operation include, for example, packed beds, tray towers, spray towers, bubble columns, membranes, and the like.

Both heat and mass transfer occur only at a liquid/air interface within the absorber unit 112 for the absorber operation 101. Heat is not removed from the liquid desiccant outside of the absorber unit 112.

In the desorber operation 102, the heat exchanger 150 may include a condenser coil within the regeneration airflow path 130 configured to add heat to the regeneration airflow. Heated regeneration airflow 131 then enters the desorber unit 114 to both heat the liquid desiccant and transfer moisture from the liquid desiccant to the heated regeneration airflow at the desorber liquid/air interface.

The desorber liquid/air interface may be formed by any vapor/liquid mass transport unit operation. Illustrative vapor/liquid mass transport unit operation include, for example, packed beds, tray towers, spray towers, bubble columns, membranes, and the like.

Both heat and mass transfer occur only at a liquid/air interface within the desorber unit 114 for the desorber operation 102. Heat is not added from the liquid desiccant outside of the desorber unit 114.

The system or liquid desiccant loop 110 does not include a refrigerant-to-liquid heat exchanger or a water-to-liquid desiccant heat exchanger. The liquid desiccant loop is a closed loop that does not include a heat exchanger unit operation, other than the heat exchange at the liquid/air interfaces within the absorber unit 112 and desorber unit 114. Heat is not added or removed from the liquid desiccant outside of the absorber unit 112 or the desorber unit 114. The liquid desiccant loop 110 includes one or more liquid pumps and it is assumed that the liquid pumps do not add appreciable heat to the liquid desiccant through the pumping action of the liquid pumps.

The liquid desiccant loop 110 may include an absorber recycle loop 113. The absorber recycle loop 113 takes liquid desiccant from the absorber unit 112 and pumps it back into the absorber unit 112. The liquid desiccant loop 110 includes transfer piping 115 to fluidly connect the liquid desiccant from the absorber unit 112 to the desorber unit 114. The liquid desiccant loop 110 includes transfer piping 116 to fluidly connect the liquid desiccant from the desorber unit 114 to the absorber unit 112.

FIG. 1 and FIG. 2 illustrate a desorber unit 114 having a single pass of liquid desiccant through the desorber unit 114. The mass flow rate of liquid desiccant through the desorber unit 114 is substantially equal to the to the mass flow rate of liquid desiccant entering the desorber unit 114 via transfer piping 115 from the absorber unit 112. The mass flow rate of liquid desiccant through the desorber unit 114 is substantially equal to the to the mass flow rate of liquid desiccant leaving the desorber unit 114 via transfer piping 116 to the absorber unit 112.

Alternatively, the liquid desiccant loop 110 may include a desorber recycle loop (not shown). The desorber recycle loop takes liquid desiccant from the desorber unit 114 and pumps it back into the desorber unit 114. In these embodiments, the mass flow rate of liquid desiccant through the desorber unit 114 is greater than either of the mass flow rate of liquid desiccant entering the desorber unit 114 via transfer piping 115 from the absorber unit 112, or the mass flow rate of liquid desiccant leaving the desorber unit 114 via transfer piping 116 to the absorber unit 112.

The liquid desiccant has a first temperature exiting the absorber unit 112 and a second temperature entering the desorber unit 114 via piping 115. The first and second temperature are within 5% of each other, or within 1% of each other, or are equal. Heat is not added to the liquid desiccant along the piping 115 from the absorber unit 112 to the desorber unit 114. Heat is not removed from the liquid desiccant along the piping 115 from the absorber unit 112 to the desorber unit 114. Heat is not added or removed along the recycle piping 113, other than minor amounts added by the fluid pumps via pumping.

The liquid desiccant has a first temperature exiting the desorber unit 114 and a second temperature entering the absorber unit 112 via piping 116. The first and second temperature are within 5% of each other, or within 1% of each other, or are equal. Heat is not added to the liquid desiccant along the piping 116 from the desorber unit 114 to the absorber unit 112. Heat is not removed from the liquid desiccant along the piping 116 from the desorber unit 114 to the absorber unit 112. Heat is not added to any desorber unit 114 recycle piping (when present) other than minor amounts added by the fluid pumps via pumping.

The regeneration airflow 130, 131 into the desorber unit 114 has a regeneration mass airflow rate value and liquid desiccant flowing through the desorber unit 114 has a desorber liquid desiccant mass flow rate value. The regeneration mass airflow rate value is in a range from 40 to 80 times the desorber liquid desiccant mass flow rate value. The regeneration mass airflow rate value is in a range from 50 to 70 times the desorber liquid desiccant mass flow rate value. The regeneration mass airflow rate value is in a range from 55 to 65 times the desorber liquid desiccant mass flow rate value.

The supply airflow 120, 121 into the absorber unit 112 has a supply mass airflow rate value and liquid desiccant flowing through the absorber unit 112 has an absorber liquid desiccant mass flow rate value. The supply mass airflow rate value is in a range from 1 to 10 times the absorber liquid desiccant mass flow rate value. The supply mass airflow rate value is in a range from 1 to 10 times the absorber liquid desiccant mass flow rate value. The supply mass airflow rate value is in a range from 1 to 5 times the absorber liquid desiccant mass flow rate value. The supply mass airflow rate value is in a range from 1 to 3 times the absorber liquid desiccant mass flow rate value.

The liquid desiccant may flow through the absorber unit 112 at an absorber liquid desiccant mass flow rate value and liquid desiccant may flow through the desorber unit 114 at a desorber liquid desiccant mass flow rate value. The desorber liquid desiccant mass flow rate value is from 0.5% to 5% of the absorber liquid desiccant mass flow rate value. The desorber liquid desiccant mass flow rate value is from 0.5% to 4% of the absorber liquid desiccant mass flow rate value. The desorber liquid desiccant mass flow rate value is from 1% to 3% of the absorber liquid desiccant mass flow rate value.

The liquid desiccant may be a halide salt solution. The halide salt can be selected from sodium chloride (NaCl), potassium chloride (KCl), potassium iodide (KI), lithium chloride (LiCl), copper(II) chloride (CuCl₂), silver chloride (AgCl), calcium chloride (CaCl₂), chlorine fluoride (ClF), bromomethane (CH₃Br), iodoform (CHI₃), hydrogen chloride (HCl), lithium bromide (LiBr) hydrogen bromide (HBr), and combinations thereof. In some embodiments, the halide salt solution is selected from LiCl, NaCl, LiBr, and CaCl₂. In some embodiments, the halide salt solution is LiCl. The solution may be water and described as an aqueous solution. The halide salt may be present in the liquid desiccant in a range from 2 to 50% wt, or in a range from 10 to 40% wt, or in a range from 20 to 40% wt.

The concentration value of liquid desiccant in the desorber unit 114 is greater than the concentration value of the liquid desiccant in the absorber unit 112. The concentration value of liquid desiccant in the desorber unit 114 may be 3% or greater, by weight, than the concentration value of the liquid desiccant in the absorber unit 112. The concentration value of liquid desiccant in the desorber unit 114 may be 4% or greater, by weight, than the concentration value of the liquid desiccant in the absorber unit 112.The concentration value of liquid desiccant in the desorber unit 114 may be 5% or greater, by weight, than the concentration value of the liquid desiccant in the absorber unit 112. The concentration value of liquid desiccant in the desorber unit 114 may be 6% or greater, by weight, than the concentration value of the liquid desiccant in the absorber unit 112. The concentration value of liquid desiccant in the desorber unit 114 may be 7% or greater, by weight, than the concentration value of the liquid desiccant in the absorber unit 112. The concentration value of liquid desiccant in the desorber unit 114 may be 8% or greater, by weight, than the concentration value of the liquid desiccant in the absorber unit 112.

The concentration value of liquid desiccant in the desorber unit 114 may be in a range from 3% to 15% greater, by weight, than the concentration value of the liquid desiccant in the absorber unit 112. The concentration value of liquid desiccant in the desorber unit 114 may be in a range from 3% to 10% greater, by weight, than the concentration value of the liquid desiccant in the absorber unit 112. The concentration value of liquid desiccant in the desorber unit 114 may be in a range from 5% to 15% greater, by weight, than the concentration value of the liquid desiccant in the absorber unit 112. The concentration value of liquid desiccant in the desorber unit 114 may be in a range from 5% to 10% greater, by weight, than the concentration value of the liquid desiccant in the absorber unit 112.

The liquid desiccant system 100 of FIG. 2 illustrates heat removed from an absorber operation 101 is added to the desorber operation 102. A vapor compressor 157 moves the refrigerant and heat from the supply airflow 120 to the regeneration airflow 130. The heat removed from the supply airflow 120 is added to the regeneration airflow 130. Additional heat from the vapor compressor 157 may also be added to the regeneration airflow 130.

In some embodiments, a portion of the heat removed from the supply airflow 120 is dissipated in a condenser unit 152 not along the regeneration airflow path 130. In other embodiments a portion of the regeneration airflow is removed from the regeneration airflow path between the heat exchanger 150 and the desorber unit 114.

A method of conditioning an airflow includes circulating liquid desiccant through a liquid desiccant loop 110 including an absorber unit 112 in fluid communication with a desorber unit 114. The method includes flowing supply air along a supply airflow path 120 and through the absorber unit 112 to form an absorber liquid/air interface within the absorber unit 112 and a conditioned airflow 122 exiting the absorber unit 112. The method includes flowing regeneration air along a regeneration airflow path 130 and through the desorber unit 114 to form a desorber liquid/air interface within the desorber unit 114 and an exhaust airflow 132 exiting the desorber unit 114. The method includes removing heat from the supply air 120 upstream of the absorber unit 112 and adding heat to the regeneration airflow 130 upstream of the desorber unit 114. The liquid desiccant has a first temperature exiting the desorber unit 114 and a second temperature entering the absorber unit 112 and the first and second temperature at within 5% of each other, or within 1% of each other, or are equal. At least 95%, or at least 99% of the total heat added to the liquid desiccant may be added at the desorber unit 114 liquid/air interface.

The method includes flowing regeneration air 130 through the desorber unit 114 at a regeneration mass airflow rate value and flowing liquid desiccant through the desorber unit 114 at a desorber liquid desiccant mass flow rate value. The regeneration mass airflow rate value is in a range from 40 to 80 times the desorber liquid desiccant mass flow rate value. The regeneration mass airflow rate value is in a range from 50 to 70 times the desorber liquid desiccant mass flow rate value. The regeneration mass airflow rate value is in a range from 55 to 65 times the desorber liquid desiccant mass flow rate value.

The method may include flowing supply air 120 through the absorber unit 112 at a supply mass airflow rate value and flowing liquid desiccant through the absorber unit 112 at an absorber liquid desiccant mass flow rate value. The supply mass airflow rate value is in a range from 1 to 10 times the absorber liquid desiccant mass flow rate value. The supply mass airflow rate value is in a range from 1 to 5 times the absorber liquid desiccant mass flow rate value. The supply mass airflow rate value is in a range from 1 to 3 times the absorber liquid desiccant mass flow rate value.

The method may include flowing liquid desiccant through the absorber unit 112 at a first mass flow rate and flowing liquid desiccant from the absorber unit 112 to the desorber 114 at a second mass flow rate. The second mass flow rate is from 0.5% to 5% of the first mass flow rate. The second mass flow rate is from 0.5% to 4% of the first mass flow rate. The second mass flow rate is from 1% to 3% of the first mass flow rate.

The removing heat step may include flowing supply air through an evaporator coil 140 within the supply airflow path 120. Adding the heat may include flowing regeneration air through a condenser coil 150 within the regeneration airflow path 130. The method does not include a refrigerant-to-liquid desiccant heat exchanger or a water-to-liquid desiccant heat exchanger.

### Example

In one embodiment, a supply airflow has a temperature of 21° C. (70° F.) an absolute humidity of 0.0128 kg H₂O/kg air and a flow rate of 1000 CFM. An evaporator coil removes heat from the supply airflow to form a cooled supply airflow having a temperature of 15° C. (60° F.) an absolute humidity of 77.3 and a flow rate of 1000 CFM entering the absorber unit. The liquid desiccant recirculating in the absorber unit and leaving the absorber unit has a temperature of 21° C. (70° F.) and a flow rate to the desorber unit of 0.25 liters/min and a recirculation flow rate of 12 liters/min. The liquid desiccant is an aqueous solution containing about 25%wt desiccant (LiCl) in the absorber unit operation. The conditioned airflow exiting the absorber unit has a temperature of 21° C. (70° F.) an absolute humidity of 0.0091 kg H₂O/kg air and a flow rate of 1000 CFM. The absorber air mass flow rate to absorber liquid desiccant mass flow rate is about 2.5:1.

In this embodiment, a regeneration airflow has a temperature of 21° C. (70° F.) an absolute humidity of 0.0128 kg H₂O/kg air and a flow rate of 550 CFM. A condenser coil adds heat to the regeneration airflow to form a heated regeneration airflow having a temperature of 38° C. (100° F.) an absolute humidity of 0.0127 kg H₂O/kg air and a flow rate of 550 CFM entering the desorber unit. The liquid desiccant circulating through the desorber unit and leaving the desorber unit has a temperature of 37° C. (98° F.) and a flow rate of 0.19 liters/min. The liquid desiccant is an aqueous solution containing about 32%wt desiccant (LiCl) in the desorber unit operation. The exhaust airflow exiting the desorber unit has a temperature of 28° C. (83° F.) an absolute humidity of 113 and a flow rate of 550 CFM. The desorber air mass flow rate to desorber liquid desiccant mass flow rate is about 61:1.

In this system, heat is added to the liquid desiccant only at the liquid/air interface within the desorber unit. In this system, heat is removed to the liquid desiccant only at the liquid/air interface within the absorber unit.

This example has demonstrated a surprising high moisture removal efficiency (MRE) of about 4 kg/kWh. MRE is the moisture removal rate (mass/time) divided by the electrical power input to the air conditioning or liquid desiccant system.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The foregoing description has been presented for the purposes of illustration and description. It is not intended to be exhaustive or to limit the embodiments to the precise form disclosed. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

1. A liquid desiccant system comprising:
a liquid desiccant loop comprising an absorber unit in fluid communication with a desorber unit and liquid desiccant flowing between the absorber unit and the desorber unit;
a supply airflow path passing through the absorber unit and forming an absorber liquid/air interface within the absorber unit and a conditioned airflow exiting the absorber unit;
a regeneration airflow path passing through the desorber unit and forming a desorber liquid/air interface within the desorber unit and an exhaust airflow exiting the desorber unit; and
a heat exchanger thermally coupled to the supply airflow path and removing heat from supply airflow upstream of the absorber unit, the heat exchanger thermally coupled to the regeneration airflow path adding heat to regeneration airflow upstream of the desorber unit;
wherein at least 95% of total heat added to the liquid desiccant is added at the desorber liquid/air interface within the desorber unit.

2. The liquid desiccant system of claim 1, wherein at least 99% of total heat added to the liquid desiccant is added at the desorber liquid/air interface within the desorber unit.

3. The liquid desiccant system of claim 1, wherein the liquid desiccant has a first temperature exiting the absorber unit and a second temperature entering the desorber unit and the first temperature and second temperature are substantially equal.

4. The liquid desiccant system of claim 1, wherein the heat exchanger comprises an evaporator coil within the supply airflow path configured to remove heat from the supply airflow.

5. The liquid desiccant system of claim 1, wherein the heat exchanger comprises a condenser coil within the regeneration airflow path configured to add heat from the regeneration airflow.

6. The liquid desiccant system of claim 1, wherein the liquid desiccant loop does not include a refrigerant-to-liquid heat exchanger or a water-to-liquid desiccant heat exchanger.

7. The liquid desiccant system of claim 1, wherein the heat removed from the supply airflow is added to the regeneration airflow.

8. The liquid desiccant system of claim 7, wherein a portion of the heat removed from the supply airflow is dissipated in a condenser unit not along the regeneration airflow path.

9. The liquid desiccant system of claim 7, wherein a portion of the regeneration airflow is removed from the regeneration airflow path between the heat exchanger and the desorber unit.

10. The liquid desiccant system of claim 1, wherein the regeneration airflow into the desorber unit has a regeneration mass airflow rate value and liquid desiccant flowing through the desorber unit has a desorber liquid desiccant mass flow rate value, and the regeneration mass airflow rate value is in a range from 40 to 80 times the desorber liquid desiccant mass flow rate value.

11. The liquid desiccant system of claim 10, wherein the supply airflow into the absorber unit has a supply mass airflow rate value and liquid desiccant flowing through the absorber unit has an absorber liquid desiccant mass flow rate value, and the supply mass airflow rate value is in a range from 1 to 10 times the absorber liquid desiccant mass flow rate value.

12. The liquid desiccant system of claim 10, wherein liquid desiccant flows through the absorber unit at an absorber liquid desiccant mass flow rate value and liquid desiccant flows through the desorber unit at desorber liquid desiccant mass flow rate value, and the desorber liquid desiccant mass flow rate value is from 0.5% to 5% of the absorber liquid desiccant mass flow rate value and the desorber liquid desiccant mass flow rate value through the desorber unit is substantially equal to a liquid desiccant mass flow rate value from the absorber unit to the desorber unit.

13. The liquid desiccant system of claim 1, wherein liquid desiccant comprises of LiCl, NaCl, LiBr, or CaCl₂.

14. The liquid desiccant system of claim 1, wherein liquid desiccant comprises LiCl.

15. The liquid desiccant system of claim 10, wherein liquid desiccant flows through the absorber unit at an absorber liquid desiccant mass flow rate value and liquid desiccant flows through the desorber unit at desorber liquid desiccant mass flow rate value, and the desorber liquid desiccant mass flow rate value is from 0.5% to 5% of the absorber liquid desiccant mass flow rate value and the desorber liquid desiccant mass flow rate value through the desorber unit is greater than a liquid desiccant mass flow rate value from the absorber unit to the desorber unit.

16. The liquid desiccant system of claim 1, wherein a concentration value of liquid desiccant in the desorber unit is 3% or greater, by weight, than a concentration value of the liquid desiccant in the absorber unit.

17. The liquid desiccant system of claim 1, wherein a concentration value of liquid desiccant in the desorber unit is 5% or greater, by weight, than a concentration value of the liquid desiccant in the absorber unit.

18. A method of conditioning an airflow comprising:
circulating liquid desiccant through a liquid desiccant loop comprising an absorber unit in fluid communication with a desorber unit and liquid desiccant;
flowing supply air along a supply airflow path and through the absorber unit to form an absorber liquid/air interface within the absorber unit and a conditioned airflow exiting the absorber unit;
flowing regeneration air along a regeneration airflow path and through the desorber unit to form a desorber liquid/air interface within the desorber unit and an exhaust airflow exiting the desorber unit;
removing heat from the supply air upstream of the absorber unit; and
adding heat to the regeneration air upstream of the desorber unit;
wherein the liquid desiccant has a first temperature exiting the desorber unit and a second temperature entering the absorber unit and the first temperature and second temperature at substantially equal.

19. The method of claim 18, further comprising flowing regeneration air through the desorber unit at a regeneration mass airflow rate value and flowing liquid desiccant through the desorber unit at a desorber liquid desiccant mass flow rate value, and the regeneration mass airflow rate value is in a range from 40 to 80 times the desorber liquid desiccant mass flow rate value.

20. The method of claim 19, further comprising flowing supply air through the absorber unit at a supply mass airflow rate value and flowing liquid desiccant through the absorber unit at a absorber liquid desiccant mass flow rate value, and the supply mass airflow rate value is in a range from 1 to 10 times the absorber liquid desiccant mass flow rate value.

21. The method of claim 19, further comprising flowing liquid desiccant through the absorber unit at a first mass flow rate and flowing liquid desiccant from the absorber unit to the desorber unit at a second mass flow rate, and the second mass flow rate is from 0.5% to 5% of the first mass flow rate.

22. The method of claim 18, wherein removing heat comprises flowing supply air through an evaporator coil within the supply airflow path, and adding the heat comprises flowing regeneration air through a condenser coil within the regeneration airflow path.

23. The method of claim 18, wherein the method does not include refrigerant-to-liquid desiccant heat exchanger or a water-to-liquid desiccant heat exchanger.

24. The method of claim 18, wherein at least 95% of total heat added to the liquid desiccant is added at the desorber liquid/air interface within the desorber unit.

25. The method of claim 18, wherein at least 99% of total heat added to the liquid desiccant is added at the desorber liquid/air interface within the desorber unit.

26. A liquid desiccant system comprising:
a liquid desiccant loop comprising an absorber unit in fluid communication with a desorber unit and liquid desiccant flowing between the absorber unit and the desorber unit;
a supply airflow path passing through the absorber unit and forming an absorber liquid/air interface within the absorber unit and a conditioned airflow exiting the absorber unit;
a regeneration airflow path passing through the desorber unit and forming a desorber liquid/air interface within the desorber unit and an exhaust airflow exiting the desorber unit; and
a heat exchanger thermally coupled to the supply airflow path and removing heat from supply airflow upstream of the absorber unit, the heat exchanger thermally coupled to the regeneration airflow path and adding heat to regeneration airflow upstream of the desorber unit;
wherein the liquid desiccant loop does not include a refrigerant-to-liquid heat exchanger or a water-to-liquid desiccant heat exchanger.

27. The liquid desiccant system of claim 26, wherein at least 99% of total heat added to the liquid desiccant is added at the desorber liquid/air interface within the desorber unit.

28. The liquid desiccant system of claim 27, wherein the liquid desiccant has a first temperature exiting the absorber unit and a second temperature entering the desorber unit and the first temperature and second temperature are substantially equal.

29. The liquid desiccant system of claim 26, wherein the heat exchanger comprises an evaporator coil within the supply airflow path configured to remove heat from the supply airflow, and the heat exchanger comprises a condenser coil within the regeneration airflow path configured to add heat to the regeneration airflow, and the heat removed from the supply airflow is added to the regeneration airflow.

30. The liquid desiccant system of claim 29, wherein a portion of the heat removed from the supply airflow is dissipated in a condenser unit not along the regeneration airflow path.

31. The liquid desiccant system of claim 26, wherein the regeneration airflow into the desorber unit has a regeneration mass airflow rate value and liquid desiccant flowing through the desorber unit has a desorber liquid desiccant mass flow rate value, and the regeneration mass airflow rate value is in a range from 40 to 80 times the desorber liquid desiccant mass flow rate value.

32. The liquid desiccant system of claim 26, wherein a concentration value of liquid desiccant in the desorber unit is 3% or greater, by weight, than a concentration value of the liquid desiccant in the absorber unit.

33. The liquid desiccant system of claim 26, wherein a concentration value of liquid desiccant in the desorber unit is 5% or greater, by weight, than a concentration value of the liquid desiccant in the absorber unit.

34. A method of conditioning an airflow comprising:
circulating liquid desiccant through a liquid desiccant loop comprising an absorber unit in fluid communication with a desorber unit and liquid desiccant;
flowing supply air along a supply airflow path and through the absorber unit to form an absorber liquid/air interface within the absorber unit and a conditioned airflow exiting the absorber unit;
flowing regeneration air along a regeneration airflow path and through the desorber unit to form a desorber liquid/air interface within the desorber unit and an exhaust airflow exiting the desorber unit;
removing heat from the supply air upstream of the absorber unit; and
adding heat to the regeneration air upstream of the desorber unit;
wherein the liquid desiccant loop does not include a refrigerant-to-liquid heat exchanger or a water-to-liquid desiccant heat exchanger.

35. The method of claim 34, wherein at least 99% of total heat added to the liquid desiccant is added at the desorber liquid/air interface within the desorber unit.

36. The method of claim 34, wherein the liquid desiccant has a first temperature exiting the absorber unit and a second temperature entering the desorber unit and the first temperature and the second temperature are substantially equal.

37. The method of claim 34, wherein the heat removed from the supply air is added to the regeneration air.

38. The method of claim 34, wherein regeneration airflow into the desorber unit has a regeneration mass airflow rate value and liquid desiccant flowing through the desorber unit has a desorber liquid desiccant mass flow rate value, and the regeneration mass airflow rate value is in a range from 40 to 80 times the desorber liquid desiccant mass flow rate value.

39. The method of claim 34, wherein a concentration value of liquid desiccant in the desorber unit is 3% or greater, by weight, than a concentration value of the liquid desiccant in the absorber unit.

40. The method of claim 34, wherein a concentration value of liquid desiccant in the desorber unit is 5% or greater, by weight, than a concentration value of the liquid desiccant in the absorber unit.
